(19) United States
(12) Patent Application Publication
(10) Pub. No.: US 2019/0293147 A1
(43) Pub. Date: Sep. 26, 2019

(54) VEHICLE DAMPER MOUNT UNIT

(71) Applicant: HONDA MOTOR CO., LTD., Tokyo (JP)

(72) Inventor: Masaki SHINKAWA, Wako-shi (JP)

(21) Appl. No.: 16/358,820

(22) Filed: Mar. 20, 2019

(30) Foreign Application Priority Data
Mar. 23, 2018 (JP) 2018-057021

(51) Int. Cl. F16F 9/54; B60G 15/02; F16F 1/373; B60G 7/02; F16F 15/04; F16F 15/03

(52) U.S. Cl. CPC F16F 9/54; B60G 15/02; F16F 15/03; B60G 7/02; F16F 15/04; F16F 1/3735

(57) ABSTRACT

A vehicle damper mount unit includes a first vibration transmission channel through which a vibration inputted from a wheel through a suspension mechanism is transmitted to a vehicle body via a damper rod and a mount rubber mechanism including a mount rubber; and a second vibration transmission channel through which the vibration inputted from a wheel through the suspension mechanism is transmitted to the vehicle body via a damper spring. The first vibration transmission channel has a metallic elastic member configured to restrict an upper limit of a stroke of the damper rod caused by the vibration transmitted. The elastic member and the mount rubber are arranged in series on the first vibration transmission channel. The vehicle damper mount unit elastically connects to an upper end of the damper rod fixed to the vehicle body and elastically supports the damper spring arranged outside the damper constituting the suspension mechanism.

### CROSS-REFERENCE TO RELATED APPLICATIONS

This application is based upon and claims the benefit of priority from Japanese Patent Application No. 2018-057021 filed on Mar. 23, 2018; the entire contents of which are incorporated herein by reference.

### BACKGROUND OF THE INVENTION

The invention relates to a vehicle damper mount unit.

For example, Patent Document 1 (Japanese Patent Application Publication No. 2009-85300) discloses a damper mount structure in which a mount rubber mechanism holding the upper end of a damper rod includes a plate having a spring function.

The damper mount structure disclosed in the Patent Document 1 adopts the following structure. That is, a rubber elastic body divided into an upper divided part and a lower divided part is connected to the upper end of the damper rod, and the upper divided part and the lower divided part have a metallic plate spring held therebetween.

In the damper mount structure disclosed by the Patent Document 1, however, the plate of the mount rubber mechanism functions as a spring. When a large load is inputted from a wheel via a suspension mechanism, the plate may be plastically deformed.

The damper mount structure disclosed in the Patent Document 1 does not restrict the upper limit of the stroke of the plate having a spring function. Therefore, the plate may cause a large resonance vibration at a resonance. These may deteriorate a NV (Noise Vibration) performance of the damper mount structure disclosed in the Patent Document 1.

### SUMMARY OF THE INVENTION

The invention is directed to a vehicle damper mount unit which further enhances a NV capability as compared with a related one.

An aspect of the invention provides a vehicle damper mount unit. The vehicle damper mount unit includes a first vibration transmission channel through which a vibration inputted from a wheel through a suspension mechanism is transmitted to a vehicle body via a damper rod and a mount rubber mechanism including a mount rubber; and a second vibration transmission channel through which the vibration inputted from a wheel through the suspension mechanism is transmitted to the vehicle body via a damper spring. The first vibration transmission channel is provided with a metallic elastic member configured to restrict an upper limit of a stroke of the damper rod which is caused by the vibration transmitted. The elastic member and the mount rubber of the mount rubber mechanism are arranged in series on the first vibration transmission channel. The vehicle damper mount unit elastically connects to an upper end of the damper rod fixed to the vehicle body and elastically supports the damper spring arranged outside the damper constituting the suspension mechanism.

According to the aspect of the invention, a vehicle damper mount unit which further enhances a NV capability more than ever is achieved.

### BRIEF DESCRIPTION OF THE ACCOMPANYING DRAWINGS

FIG. 1 is a schematic cross-sectional diagram of a structure of the vehicle damper mount unit according to an embodiment of the present invention;

FIG. 2 is a schematic equivalent circuit diagram of the vehicle damper mount unit as illustrated in FIG. 1;

FIG. 3 is a schematic equivalent circuit diagram of a variation example of the vehicle damper mount unit as illustrated in FIG. 1;

FIG. 4 is a magnified cross-sectional diagram of the vehicle damper mount unit as illustrated in FIG. 1, which illustrates a bottoming condition in which a lower disc spring is flatly deformed due to a vibration transmitted from a damper rod;

FIG. 5 is a schematic cross-sectional diagram of a structure of the vehicle damper mount unit according to another embodiment of the present invention;

FIG. 6 is a magnified schematic cross-sectional diagram of the vehicle damper mount unit as illustrated in FIG. 5, which illustrates a bottoming condition in which a lower disc spring is flatly deformed due to a vibration transmitted from a damper rod; and

FIG. 7 is a schematic equivalent circuit diagram of a vehicle damper mount unit according to a comparative example as devised by the applicant.

### DETAILED DESCRIPTION OF THE EMBODIMENTS

Embodiments of the present invention will be hereinafter described in detail with reference to the accompanying drawings as necessary.

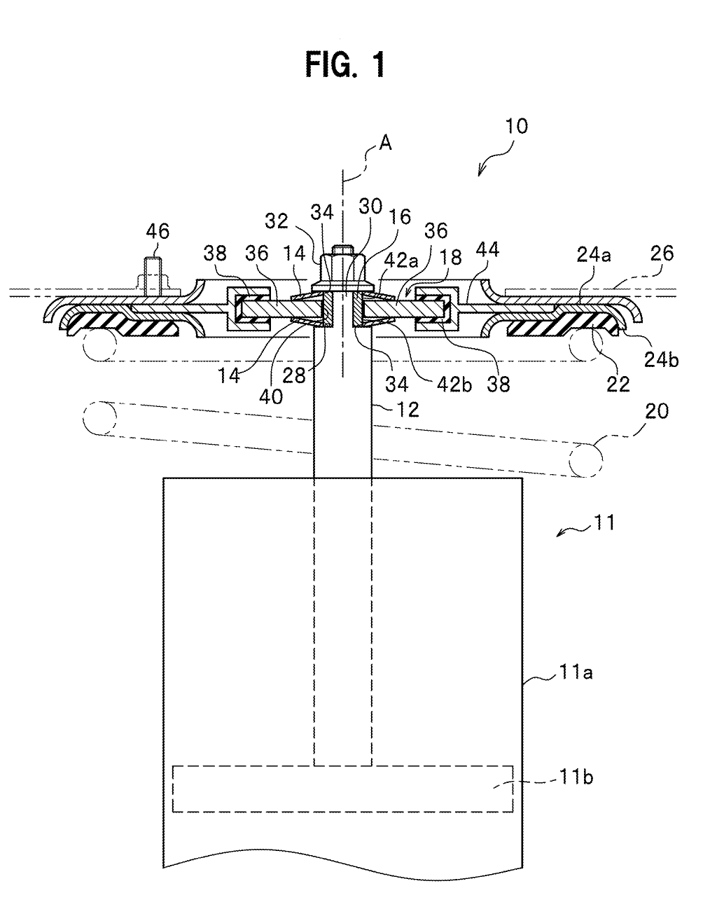

As illustrated in FIG. 1, a vehicle damper mount unit 10 (hereinafter simply referred to as a “damper mount 10”) includes a damper rod 12, a pair of disc springs (metal-made elastic members) 14, 14, a collar member 16, and a mount rubber mechanism 18. A damper spring 20 is disposed outside the damper rod 12.

In the damper mount 10, the mount rubber mechanism 18 elastically connects the damper rod 12 to a vehicle body member. The damper mount 10 is used for the vehicle body of type in which the damper spring 20 directly receives vehicle load without using the mount rubber mechanism 18.

The damper rod 12 is connected to a damper piston 11b housed inside a damper tube 11a of the damper 11, and its part is exposed to the outside from the damper tube 11a. The damper tube 11a is filled with a working medium (for example, a working fluid, a magnetic fluid or the like), and the damper rod 12 is integrally displaced together with the damper piston 11b. Incidentally, the damper tube 11a is connected to a knuckle (not illustrated) of a suspension mechanism.

The damper piston 11b and the damper rod 12 are provided capable of reciprocating (moving backwards and forwards) in an axial direction of the damper tube 11a due to vibration transmitted from a wheel (not illustrated). The damper 11 reduces the vibration which is transmitted from the wheel (not illustrated) via the suspension mechanism.

The damper spring 20 is arranged surrounding the damper tube 11a (the damper rod 12). The damper spring 20 is made of a coil spring whose outer diameter is larger than that of the damper tube 11a. One end (an upper end) of the damper spring 20 is fastened and fixed to the vehicle body member 26 using a rubber-made spring seat 22 and attachment brackets 24a, 24b, which will be described later. On the other hand, the other end (the lower end) of the damper spring 20 is elastically connected, for example, to a lower arm (not illustrated) of the suspension mechanism.

The damper rod 12 is formed in a substantially columnar shape. A ring-shaped step part 28 is formed in an upper end of the damper rod 12 in an axial direction of the damper rod 12, and its diameter is smaller than that of the rest of the damper rod 12. In addition, the center of the ring-shaped step part 28 in the upper end of the damper rod 12 has a fastener part 30 which is formed in a rod shape extending in the axial direction of the damper rod 12 and which includes a screw portion formed partially on the outer circumference surface.

A nut member 32 is provided capable of being screwed to the screw portion of the fastener part 30. The nut member 32 is fastened to the fastener part 30 of the damper rod 12, and thereby, the pair of disc springs 14, 14, the collar member 16 and the mount rubber mechanism 18 are fastened together. Incidentally, the nut member 32 and the upper disc spring 14 touch each other while in line contact with each other.

The pair of disc springs 14, 14 are metal-made members, and have substantially the same configuration. Each disc spring 14 includes a through-hole 34 penetrating through the center from the upper to lower surfaces of the disc spring 14, and is formed in a substantially conic shape. The disc spring 14 includes: a conic upper portion which is adjacent to the through-hole 34 and has a smaller diameter; and a conic lower portion which continues from the conic upper portion and has a larger diameter. In this case, the inputted vibration decreases the height-direction dimension of the disc spring 14, and bends (deforms) the disc spring 14 into a substantially flat-plate shape. Thus, the disc spring 14 exerts spring force. Incidentally, examples of the material of the disc spring 14 include carbon steel, alloy steel, stainless steel, and copper alloy.

It should be noted that the spring constant of each disc spring 14 needs to be set appropriately because: too low a spring constant makes the disc spring 14 easily get bottomed and therefore incapable of absorbing micro-vibration; and too high a spring constant makes the disc spring 14 easily transmit vibration to the vehicle body member. It is preferable that the spring constant be, for example, 0.5 to 20 kN/mm. The contact of the nut member 32 with the collar member 16 compresses and holds the pair of disc springs 14, 14 between the nut member 32 and the ring-shaped step part 28 of the damper rod 12.

The pair of disc springs 14, 14 are arranged around the one end (the upper end) of the damper rod 12 such that the disc springs 14, 14 lap each other in the axial direction of the damper rod 12 while facing in the vertically opposite directions. Specifically, the upper disc spring 14 is arranged with its conic upper portion, inclusive of the through-hole 34, facing upward while the lower disc spring 14 is arranged with its conic upper portion, inclusive of the through-hole 34, facing downward. Axes of the respective disc springs 14, 14 (straight lines passing through the centers of the through-holes 34) are arranged coaxially with each other, and further coaxially with the axis of the damper rod 12. Moreover, the pair of disc springs 14, 14 and a mount rubber 38 (described later) of the mount rubber mechanism 18 are arranged in series.

The collar member 16 whose outer diameter is slightly smaller than the inner diameters of the through-holes 34 is attached inside the through-holes 34 of the respective upper and lower disc springs 14, 14. The collar member 16 is made of a metal-made cylindrical body, and is installed between the fastener part 30 of the damper rod 12 and the pair of disc springs 14, 14 in a radial direction. The lower end of the collar member 16 is brought into contact with the ring-shaped step part 28 of the damper rod 12, and the collar member 16 is thereby positioned. Furthermore, the collar member 16 is arranged in a part where a plate member 36 (described later) is attached to the fastener part 30 of the damper rod 12. The collar member 16 extends in the axial direction of the damper rod 12.

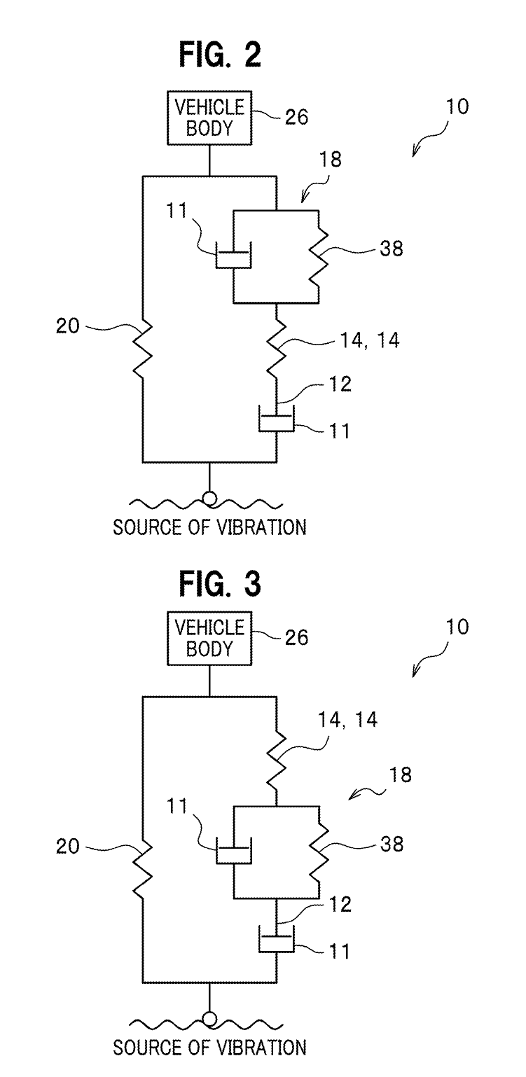

The mount rubber mechanism 18 includes: the plate member 36 made of metal and shaped in an annular shape; and the mount rubber 38 which holds the outer peripheral edge portion of the plate member 36. The plate member 36 has a substantially disc shape. A through-hole 40 through which the fastener part 30 of the damper rod 12 is inserted is formed in the center of the plate member 36. The insertion of the fastener part 30 of the damper rod 12 through the through-hole 40 of the plate member 36 installs the plate member 36 between the pair of disc springs 14, 14. Furthermore, as illustrated in FIG. 2, the mount rubber 38 and the pair of disc springs 14, 14 are arranged in series. Incidentally, in FIG. 2, the pair of disc springs 14, 14 are represented by a single symbol.

There is provided clearances between the facing surfaces of the plate member 36 and the disc springs 14, 14 in the axial direction of the damper rod 12. The clearances include an upper clearance 42a located above the plate member 36; and a lower clearance 42b located below the plate member 36.

The upper clearance 42a is provided between the facing surfaces of the upper disc spring 14 and the plate member 36, that is to say, an inner surface of the upper disc spring 14 and an upper surface of the plate member 36, and in a part on the side of the axis A of the damper rod 12 (the fastener 30) (an area adjacent to the axis thereof). Incidentally, the peripheral edge portion farthest in the upper disc spring 14 from the axis A of the damper rod 12 pressingly contacts with the upper surface of the plate member 36 while in line contact with the upper surface thereof.

The lower clearance 42b is provided between the facing surfaces of the lower disc spring 14 and the plate member 36, that is to say, the inner surface of the lower disc spring 14 and the lower surface of the plate member 36, and in a part on the side of the axis A of the damper rod 12 (the fastener part 30) (an area adjacent to the axis thereof). Incidentally, the peripheral edge portion farthest in the lower disc spring 14 from the axis A of the damper rod 12 pressingly contacts with the lower surface of the plate member 36 while in line contact with the lower surface thereof.

As discussed above, the pair of disc springs 14, 14 are provided with the clearances (the upper clearance 42a and the lower clearance 42b) which are between the disc springs 14, 14 and the plate member 36 on the side of the axis A of the damper rod 12 (the fastener part 30). The damper rod 12 is provided displaceable (strokeable) relative to the plate member 36 in the axial direction of the damper rod 12 by these clearances.

The mount rubber 38 made of a ring-shaped rubber elastic body whose cross section is formed in a substantially U-shape, and which extends along all the outer peripheral edge portion of the plate member 36. The mount rubber 38 is also joined (for example, cure-bonded) to the plate member 36 such that the mount rubber 38 covers both the front and back surfaces of part of the outer peripheral edge portion of the plate member 36.

A bracket 44 is arranged on the outer-diameter side of the mount rubber 38. The bracket 44 covers the mount rubber 38, and extends in the outer-diameter direction of the plate member 36. The outer peripheral portion of the bracket 44 is held between a pair of upper and lower attachment brackets 24a, 24b. A rubber-made spring seat 22 which supports an upper end of the damper spring 20 is attached to the lower attachment bracket 24b. The pair of attachment brackets 24a, 24b are fastened and fixed to the vehicle body member 26 (for example, a vehicle body panel) using a fastener bolt 46.

The vehicle damper mount unit 10 according to the embodiment basically has the above-discussed configuration. Next, descriptions will be provided for how the vehicle damper mount unit 10 works, and what effects the vehicle damper mount unit 10 brings about.

To begin with, descriptions will be provided for two transmission channels via which vibration inputted from the wheel is transmitted to the vehicle body. Incidentally, the vibration is not transmitted via only a selected one of the two transmission channels. For example, there are cases where the vibration inputted from the wheel is transmitted via the two transmission channels in parallel.

A first vibration transmission channel transmits the vibration, transmitted from the wheel via the suspension mechanism, to the vehicle body member 26 via the followings.

The first vibration transmission channel transmits the vibration via the damper tube 11a of the damper 11, the working medium in the damper tube 11a, the damper rod 12, the pair of disc springs 14, 14, the plate member 36, the mount rubber 38 and the vehicle body member 26 in this order.

A second vibration transmission channel transmits the vibration, transmitted from the wheel via the suspension mechanism, to the vehicle body member 26 via the followings.

The second vibration transmission channel transmits the vibration via the damper tube 11a of the damper 11, the damper spring 20, and the vehicle body member 26 in this order.

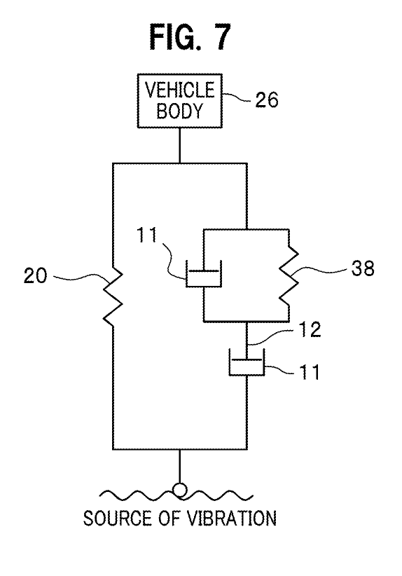

Next, a comparative example, illustrated in FIG. 7, devised by the present applicant, and the embodiment will be compared and described. The comparative example has the same configuration as the embodiment, except that no pair of disc springs 14, 14 are arranged in the first vibration transmission channel in the comparative example.

Regarding the comparative example illustrated in FIG. 7, in the first vibration transmission channel, the vibration transmitted from the wheel via the suspension mechanism is reduced by the working medium in the damper tube 11a, and the mount rubber 38. The working medium (the damper 11) and the mount rubber 38 (the rubber elastic body) arranged in the first vibration transmission channel have difficulty in quickly following an increase in the frequency (high frequency) of the vibration transmitted from the wheel and exerting the damping capability. Because of the deterioration in the followability of the damping capability, the comparative example is likely to decrease the capability of reducing the vibration transmitted from the wheel, and to transmit the vibration to the vehicle body member 26.

Regarding the embodiment, in the first vibration transmission channel, the pair of metal-made disc springs 14, 14 and the mount rubber 38 are arranged in series while the metal-made disc springs 14, 14 cover each other in the axial direction of the damper rod 12. This makes the embodiment exert the damping capability using the pair of metal-made disc springs 14, 14 upon an increase in the frequency of the vibration transmitted from the wheel increases, and accordingly enables the embodiment to enhance the followability. Thus, the embodiment can enhance the noise/vibration (NV) capability more than ever. Incidentally, in the embodiment, relatively large vibration is reduced by the mount rubber 38 arranged in series downstream of the pair of disc springs 14, 14.

In the embodiment, the pair of disc springs 14, 14 are arranged on the side of the damper 11 in the first vibration transmission channel while the mount rubber mechanism 18 is arranged on the side of the vehicle body in the first vibration transmission channel. In the embodiment, therefore, the pair of disc springs 14, 14 easily absorb micro-vibration (high-frequency micro-vibration) which is transmitted by the first vibration transmission channel and caused by road noise. Furthermore, since the pair of disc springs 14, 14 are arranged upstream of the mount rubber mechanism 18, the embodiment is capable of exerting the damping capability instantaneously, and thus enhances the followability. Incidentally, as shown by a modification in FIG. 3, the pair of disc springs 14, 14 may be arranged downstream of the mount rubber mechanism 18. That is, the disc spring 14 is arranged between the attachment bracket 24a and the vehicle body 26 or between the bracket 44 and the attachment bracket 24a.

In addition, the embodiment suitably absorbs the micro-vibration (the high-frequency micro-vibration), caused by the road noise, using the pair of disc springs 14, 14 by appropriately setting the upper clearance 42a and the lower clearance 42b formed between the pair of disc springs 14, 14 and the plate member 36. Because of being made of the metal material, the pair of disc springs 14, 14 do not cause a change in the spring constant or a delay in the phase, and accordingly absorbs the micro-vibration efficiently. Thus, the embodiment enhances the NV capability more than ever. Incidentally, the upper clearance 42a and the lower clearance 42b may be set, for example, in a range of 0.1 to 0.5 mm.

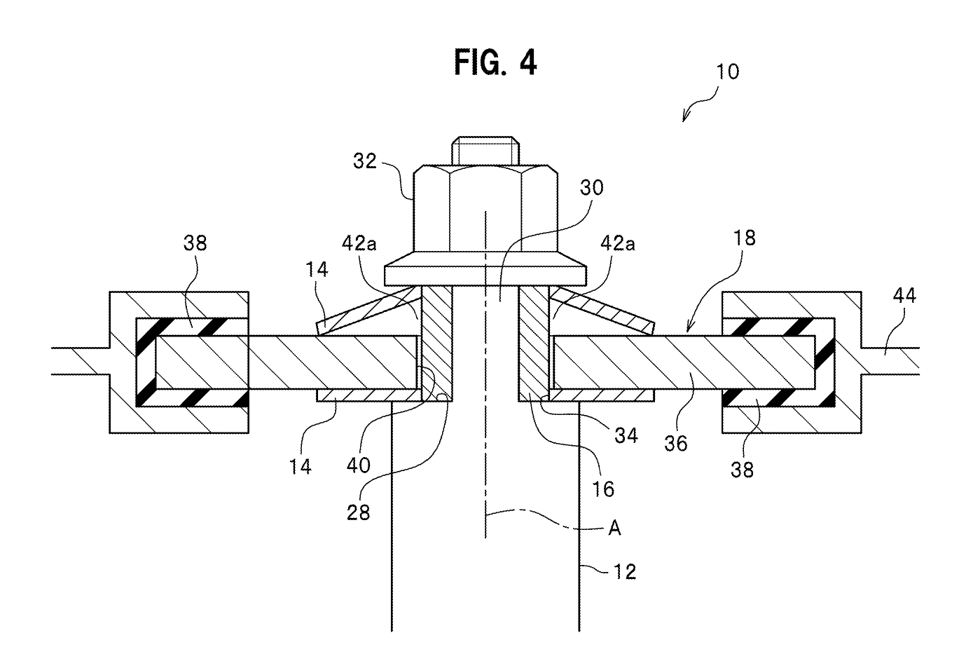

Furthermore, in the embodiment, the clearances (the upper clearance 42a and the lower clearance 42b) of the pair of metal disc springs 14, 14 restrict an upper limit of a stroke of the damper rod 12 relative to the plate member 36 which is caused by the transmitted vibration. In the embodiment, in a case where the displacement of the damper rod 12 is transmitted to one of the disc springs 14, 14 and the damper rod 12 is accordingly displaced to the upper limit of the stroke, the other disc spring 14 is compressed and held. In this respect, the “compressed and held” means, for example, that the upper disc spring 14 is compressed and held between the nut member 32 and the plate member 36 (see FIG. 4, which will be discussed). If the other disc spring 14 is not compressed and held, a problem arises in which a gap occurs between the disc spring 14 and the plate member 36 and thus makes strange noise.

FIG. 4 is a magnified cross-sectional diagram illustrating a bottoming condition in which the lower disc spring is flatly deformed due to vibration transmitted from the damper rod.

In the embodiment, even in the case where the lower disc spring 14 gets bottomed and deformed into a flat shape, the upper disc spring 14 is compressed and held between the nut member 32 and the plate member 36 (in the compressed and condition). This prevents load from escaping from the upper disc spring 14 which is opposite from the lower disc spring 14. The embodiment thereby restricts the upper limit of the stroke of the damper rod 12 which is caused by the vibration transmitted from the wheel. Incidentally, each disc spring 14 is set to have a shape capability which does not allow the disc spring 14 to get elastically deformed even if getting bottomed.

In the embodiment, the length of the elastic deformation of the fastener part 30 of the damper rod 12 becomes larger as the length of the collar member 16 becomes larger in the axial direction of the damper rod 12. This suitably avoids the looseness of the nut member 32 from the fastener part 30 of the damper rod 12.

In the embodiment, the damper rod 12 is not directly fastened to the plate member 36, and the pair of disc springs 14, 14 support the plate member 36. Even in a case where, for example, steering operation of a steering mechanism (not illustrated) inputs rotational force into the damper rod 12 in the circumferential direction of the damper rod 12, the embodiment prevents the occurrence of the looseness of the nut member 32, and suitably avoids the occurrence of strange noise.

In the embodiment, the collar member 16 is arranged in the part where the plate member 36 is pivotally attached to the damper rod 12, and the collar member extends in the axial direction of the damper rod 12. The length of the collar member in the axial direction of the damper rod 12 restricts the clearance of each disc spring 14 by regulating the amount of screwing of the nut member to the fastener part of the damper rod, and also has a function of preventing the looseness of the nut member 32 from the fastener member 30 of the damper rod 12.

The embodiment is advantageous in reducing the use amount of sound insulation material arranged in the vehicle body by the enhancement in the NV capability beyond the conventional NV capability.

Furthermore, an anti-corrosion effect is provided to the pair of disc springs 14, 14 by plating the disc springs 14, 14, or by using stainless steel as the material of the disc springs 14, 14.

The wear of the disc springs is inhibited by setting the hardness of each disc members 14 higher than those of the damper rod 12 and the nut member 32.

Next, descriptions will be provided for a vehicle damper mount unit according to a second embodiment of the present invention.

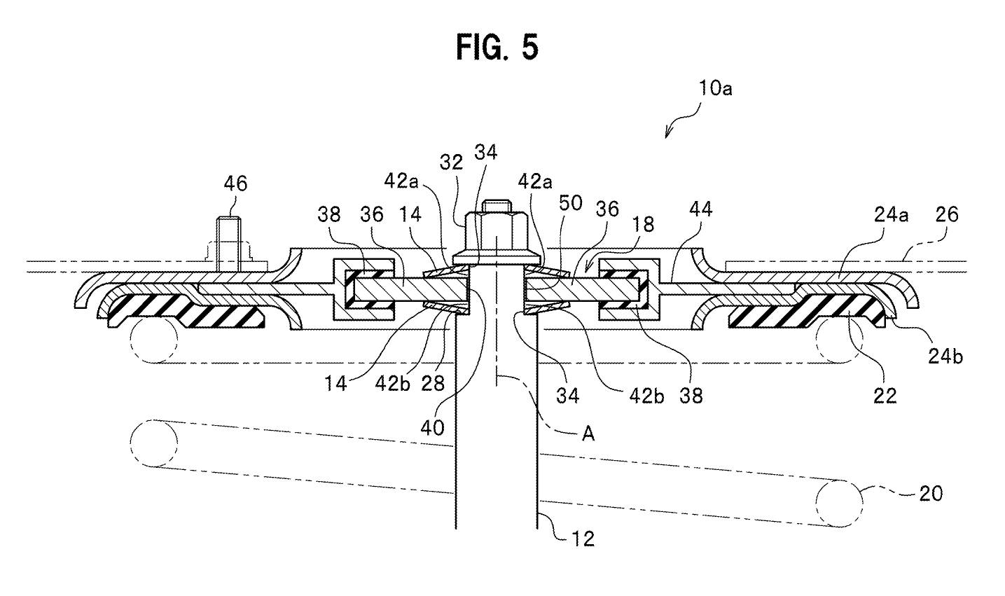

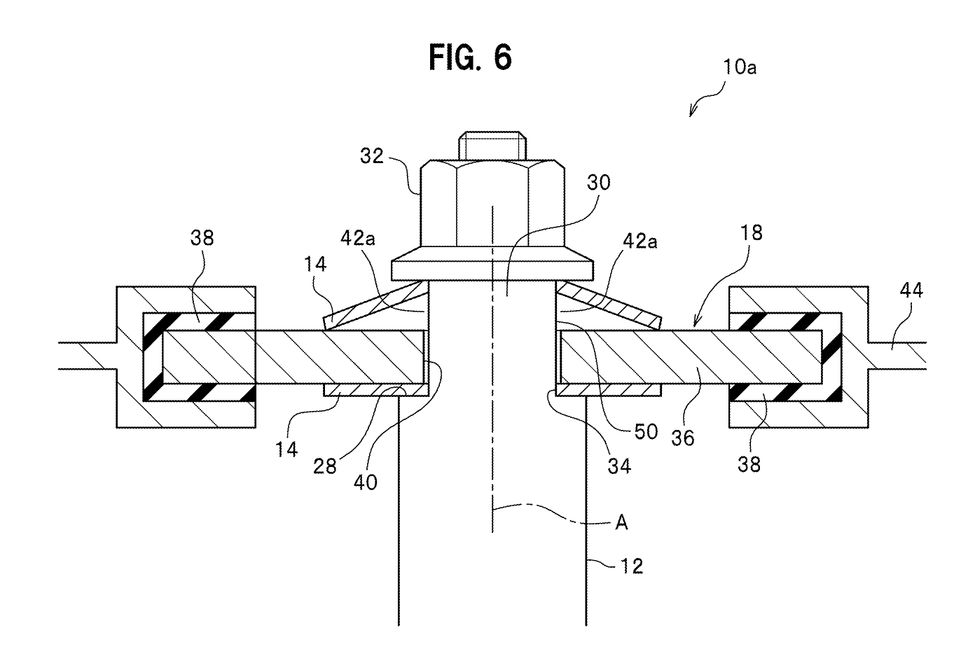

FIG. 5 is a schematic cross-sectional diagram of a configuration of the vehicle damper mount unit according to the second embodiment of the present invention. FIG. 6 is a magnified cross-sectional diagram corresponding to FIG. 4. Incidentally, components which are the same as those in the previous embodiment (the first embodiment) will be denoted by the same references signs, and descriptions for them will be omitted.

The second embodiment is different from the first embodiment in that a stepped rod part 50 is provided between the ring-shaped step part 28 of the damper rod 12 and the fastener part 30 of the damper rod 12. The second embodiment omits the collar part 16 by forming the stepped rod part 50 by joggling. The second embodiment thus reduces the number of parts and accordingly the manufacturing costs.

The working of the vehicle damper mount unit according to the second embodiment and the effects brought about by the vehicle damper unit according to the second embodiment are the same as those of the first embodiment, and descriptions for them will be omitted.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A vehicle damper mount unit comprising:
a first vibration transmission channel through which a vibration inputted from a wheel through a suspension mechanism is transmitted to a vehicle body via a damper rod and a mount rubber mechanism including a mount rubber; and
a second vibration transmission channel through which the vibration inputted from a wheel through the suspension mechanism is transmitted to the vehicle body via a damper spring,
wherein the first vibration transmission channel is provided with a metallic elastic member configured to restrict an upper limit of a stroke of the damper rod which is caused by the vibration transmitted, and
wherein the elastic member and the mount rubber of the mount rubber mechanism are arranged in series on the first vibration transmission channel, and
wherein the vehicle damper mount unit elastically connects to an upper end of the damper rod fixed to a vehicle body and elastically supports the damper spring arranged outside the damper constituting the suspension mechanism,.

2. The vehicle damper mount unit according to claim 1,
wherein the elastic member is disposed closer to the damper on the first vibration transmission channel, and
wherein the mount rubber mechanism is disposed closer to the vehicle body on the first vibration transmission channel.

3. The vehicle damper mount unit according to claim 1,
wherein the elastic member comprises a first disc spring and a second disc spring, and
wherein the first disc spring and the second disc spring are arranged to lap each other in an axial direction of the damper rod.

4. The vehicle damper mount unit according to claim 3,
wherein the first disc spring and the second disc have a plate member interposed therebetween and the plate member is pivotally attached to the damper rod,
wherein the first disc spring and the plate member have respectively opposite surfaces having a clearance therebetween in the axial direction of the damper rod, and
wherein the second disc spring and the place member have respectively opposite surfaces having a clearance therebetween in the axial direction of the damper rod.

5. The vehicle damper mount unit according to claim 4,
wherein when a displacement of the damper rod is transmitted to one spring of the first disc spring and the second disc spring and said one spring is displaced to the upper limit of the stroke, the other spring is compressed and held.

6. The vehicle damper mount unit according to claim 4,
wherein the plate member includes a portion which is pivotally attached to the damper rod and at which a collar member is disposed, and
wherein the collar member extends in the axial direction of the damper rod.
